(19) United States
(12) Patent Application Publication
(10) Pub. No.: US 2005/0227065 A1
(43) Pub. Date: Oct. 13, 2005

(54) Thermal-reaction type flame-retardant pressure-sensitive adhesive tape and process for producing the same

(76) Inventors: Hiroaki Nishimura, Kawasaki-shi (JP); Takahiro Sakai, Kawasaki-shi (JP); Kazuo Nate, Kawasaki-shi (JP)

Correspondence Address: BIRCH STEWART KOLASCH & BIRCH, PO BOX 747, FALLS CHURCH, VA, 22040-0747, US

(21) Appl. No.: 10/344,276

(22) PCT Filed: Aug. 19, 2002
(86) PCT No.: PCT/JP02/08352

§ 371 Date: Feb. 10, 2003

(30) Foreign Application Priority Data
Aug. 20, 2001 (JP) 2001-248567
Aug. 20, 2001 (JP) 2001-248572

(51) Int. Cl. B32B 27/06; B32B 31/00

(52) U.S. Cl. 428/355 R; 156/275.5; 156/275.7

(57) ABSTRACT

A thermo-reactive flame-retardant adhesive tape having high flame-retardancy and a method for producing the same are disclosed. The adhesive tape comprises a substrate and a solvent-less type photo-curing pressure-sensitive adhesive applied onto the substrate, the solvent-less type photo-curing pressure-sensitive adhesive comprising a photo-curing pressure-sensitive adhesive, as well as a dripping inhibitor and a flame retardant both added into the photo-curing pressure-sensitive adhesive, the photo-curing pressure-sensitive adhesive containing as main components at least a (metha)acrylic acid alkyl ester monomer, a polar group-containing monomer, and a photo-polymerization initiator. Based on 100 parts by weight of the photo-curing pressure-sensitive adhesive, 5-50 parts by weight of a hydroxyl-containing monomer having a photo-active functional group, as well as 5-100 parts by weight of phosphazene and 10-200 parts by weight of hydrated alumina, are added as the dripping inhibitor and the flame retardant, respectively, to the photo-curing pressure-sensitive adhesive.

### TECHNICAL FIELD

The present invention relates to a thermo-reactive flame-retardant adhesive tape comprising a substrate and a solvent-less type photo-curing pressure-sensitive adhesive applied onto the substrate, the solvent-less type photo-curing pressure-sensitive adhesive comprising an acrylic photo-curing pressure-sensitive adhesive as well as a dripping inhibitor and a flame retardant both added into the acrylic photo-curing pressure-sensitive adhesive, and a method for producing the same.

### BACKGROUND ART

Recently, in the industry of electric and electronic field, in order to meet the requirement for higher performance and higher function of products and an increase in the number of product types, there has been an increasing demand for higher flame-retardancy, higher heat resistance, higher adhesiveness, and higher reliability with respect to adhesives and pressure-sensitive adhesives which are used for bonding parts. Particularly from the standpoint of improving the working efficiency and improving the working environment, it is becoming more and more popular to bond various parts with use of adhesive tapes or sheets instead of liquid adhesives.

According to a conventional method generally adopted for imparting flame-retardancy to such adhesive tapes, both a halogen-based flame retardant and antimony oxide are used in combination. However, the halogen-based flame retardant generates a halogen gas which is toxic to the human body during combustion, or may cause corrosion of devices and the like. Therefore, a flame-retarding method of the type not using such a halogen-based flame retardant is now keenly desired.

As a flame-retarding method not using a halogen-based flame retardant there is known a method which uses a hydrated metallic compound such as magnesium hydroxide or aluminum hydroxide. However, for attaining a high flame-retardancy effect it is necessary that a large amount of such a hydrated metallic compound be added into a pressure-sensitive adhesive, thus giving rise to the problem that the adhesive property is impaired.

In Japanese Published Unexamined Patent Application No. 193187/1996 there is proposed an adhesive tape using as a flame-retardant a mixture of a nitrogen-containing phosphorus compound, e.g., ammonium polyphosphate, and red phosphorus. However, since untreated red phosphorus is used, the problem of phosphine gas evolution is involved therein.

Besides, as to the flame-retardancy standard, restrictions on the U.S. (Underwriters Laboratory) vertical flame test have been becoming more and more strict every year, and for the reduction of weight and for the improvement of economic advantages, the adhesive tape thickness is becoming thinner, thus giving rise to the problem that dripping (drop of molten resin) occurs during combustion, with consequent spread of flames.

Such a polymer as that used in a pressure-sensitive adhesive drips during combustion and causes deterioration of flame-retardancy.

As a method for suppressing such dripping there is known a method wherein the polymer is cross-linked with a poly-functional monomer for example, as described in Japanese Published Unexamined Patent Application No. 14393/2000.

However, the method disclosed in the JP-A No. 14393/2000 involves the problem that the cross-linking density must be made high for suppressing the dripping to a satisfactory extent and the adhesive property is impaired thereby.

The present invention has been effected for solving the above-mentioned problems and it is an object of the invention to provide a flame-retardant adhesive tape superior in both flame-retardancy and dripping suppressing effect and further superior in basic adhesive characteristics.

### DISCLOSURE OF THE INVENTION

For achieving the above-mentioned object the present invention adopts such a construction as described in the appended claims.

That is, according to the present invention there is provided a thermo-reactive flame-retardant adhesive tape comprising a substrate and a solvent-less type photo-curing pressure-sensitive adhesive applied onto the substrate, the solvent-less type photo-curing pressure-sensitive adhesive comprising a photo-curing pressure-sensitive adhesive, as well as a dripping inhibitor and a flame retardant both added into the photo-curing pressure-sensitive adhesive, the photo-curing pressure-sensitive adhesive containing as main components at least a (metha)acrylic acid alkyl ester monomer, a polar group-containing monomer, and a photo-polymerization initiator.

In this case, based on 100 parts by weight of the photo-curing pressure-sensitive adhesive, 5-50 parts by weight of a hydroxyl-containing monomer having a photo-active functional group and 5-100 parts by weight of phosphazene are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxyl-containing monomer having a photo-active functional group, as well as 5-100 parts by weight of phosphazene and 10-200 parts by weight of hydrated alumina, are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxyl-containing monomer having a photo-active functional group, as well as 5-100 parts by weight of phosphazene and 5-100 parts by weight of ammonium polyphosphate, are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxyl-containing monomer having a photo-active functional group, as well as 5-100 parts by weight of phosphazene and 10-200 parts by weight of hydrated alumina and 5-100 parts by weight of ammonium polyphosphate, are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxy-containing monomer having a photo-active functional group and 5-50 parts by weight of inorganic coated red phosphorus are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxyl-containing monomer having a photo-active functional group and 10-200 parts by weight of hydrated alumina are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxyl-containing monomer having a photo-active functional group, as well as 5-50 parts by weight of inorganic coated red phosphorus and 10-200 parts by weight of hydrated alumina, are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxy-containing monomer having a photo-active functional group and 10-200 parts by weight of ammonium polyphosphate are added as the dripping inhibitor and the flame retardant, respectively, to the photo-curing pressure-sensitive adhesive.

In this case, based on 100 parts by weight of the photo-curing pressure-sensitive adhesive, 5-50 parts by weight of a hydroxyl-containing monomer having a photo-active functional group, as well as 5-50 parts by weight of inorganic coated red phosphorus and 10-200 parts by weight of ammonium polyphosphate, are added as the dripping inhibitor and the flame retardant, respectively, to the photo-curing pressure-sensitive adhesive.

In the above cases, an oxygen index is not smaller than 23.

According to the present invention there is further provided a method for producing the above thermo-reactive flame-retardant adhesive tape wherein a layer of the photo-curing pressure-sensitive adhesive formed by applying the above solvent-less type photo-curing pressure-sensitive adhesive containing the above flame retardant onto the substrate to a thickness of 5-500 μm is cured by light irradiation in an inert gas atmosphere or while covering the layer with a transparent protective film from above.

### BEST MODE FOR CARRYING OUT THE INVENTION

The present invention resides in a thermo-reactive flame-retardant adhesive tape comprising a substrate and a solvent-less type photo-curing pressure-sensitive adhesive comprising a photo-curing pressure-sensitive adhesive, as well as a dripping inhibitor and a flame retardant both added into the photo-curing pressure-sensitive adhesive, the photo-curing pressure-sensitive adhesive containing as main components at least a (metha)acrylic acid alkyl ester monomer, a polar group-containing monomer, and a photo-polymerization initiator. The invention is characterized in that the solvent-less type photo-curing pressure-sensitive adhesive having incorporated therein the following components relative to 100 parts by weight thereof is applied onto the substrate: 5-50 parts by weight of a hydroxyl-containing monomer having a photo-active functional group and 5-100 parts by weight of phosphazene; or 5-50 parts by weight of a hydroxyl-containing monomer having a photo-active functional group, 5-100 parts by weight of phosphazene, and 10-200 parts by weight of hydrated alumina; or 5-50 parts by weight of a hydroxyl-containing monomer having a photo-active functional group, 5-100 parts by weight of phosphazene, and 5-100 parts by weight of ammonium polyphosphate; or 5-50 parts by weight of a hydroxyl-containing monomer having a photo-active functional group, 5-100 parts by weight of phosphazene, 10-200 parts by weight of hydrated alumina, and 5-100 parts by weight of ammonium polyphosphate; or 5-50 parts by weight of a hydroxyl-containing monomer having a photo-active functional group and 5-50 parts by weight of inorganic coated red phosphorus; or 5-50 parts by weight of a hydroxyl-containing monomer having a photo-active functional group and 10-200 parts by weight of hydrated alumina; or 5-50 parts by weight of a hydroxyl-containing monomer, 5-50 parts by weight of inorganic coated red phosphorus, and 10-200 parts by weight of hydrated alumina; or 5-50 parts by weight of a hydroxyl-containing monomer and 10-200 parts by weight of ammonium polyphosphate; or 5-50 by weight of a hydroxyl-containing monomer, 5-50 parts by weight of inorganic coated red phosphorus, and 10-200 parts by weight of ammonium polyphosphate. The thermo-reactive type flame-retardant adhesive tape according to the present invention suppresses dripping during combustion, does not evolve such toxic gases as halogen gases and phosphine gas, nor does it contain antimony that exerts a harmful influence on the human body, is superior in basic adhesive characteristics such as adhesive strength and holding power, and possesses flame-retardancy. In the dripping inhibitor, hydroxyl groups undergo a dehydro-condensation reaction during combustion, whereby the bonding force of the main polymer chain is strengthened to inhibit dripping.

The dripping inhibitor used is a hydroxyl-containing monomer having a photo-active functional group. Examples are general-purpose 2-hydroxyethyl acrylate, 2-hydroxypropyl acrylate, and 4-hydroxybutyl acrylate.

It is preferable that the hydroxyl-containing monomer having a photo-active functional group be used at a proportion of 5-50 parts by weight based on 100 parts by weight of the photo-curing pressure-sensitive adhesive. If the proportion of the hydroxyl-containing monomer having a photo-active functional group is less than 5 parts by weight, dripping will not be suppressed to a satisfactory extent, with consequent deterioration of flame-retardancy. If it exceeds 50 parts by weight, a lowering of adhesive strength will result because of a high glass transition temperature of the hydroxyl-containing monomer having a photo-active functional group, although dripping will be suppressed.

As examples of the phosphazene used there are mentioned trade names SA-100, SPR-100, NF-46, NF-68, and NF-100, which are products of Otsuka Chemical Co.

Phosphazene decomposes during combustion to produce phosphoric acid or poly-phosphoric acid, which further forms a char layer to shield the tape from heat and oxygen, whereby flame-retardancy is exhibited.

As examples of the red phosphorus used there are mentioned such inorganic coated, stabilized red phosphorus flame retardants as trade names CP-A15, TP-10, CP-A15F, TP-10F, Hishiguard Safe PM-13, PM-24, PM-31, Hishiguard White CP, TP, which are products of Nippon Chemical Industrial Co.

Red phosphorus decomposes during combustion to produce phosphoric acid or poly-phosphoric acid, which further forms a char layer to shield the tape from heat and oxygen, whereby flame-retardancy is exhibited.

The hydrated alumina used is not specially limited, but is one having a specific surface area of not larger than 5 m²/g and an average particle diameter in the range of 3 to 25 μm. The use of a hydrated alumina not satisfying these conditions will affect the process-ability and precipitat-ability of the pressure-sensitive adhesive. Examples of the hydrated alumina used include trade names H-X, H-21, H-31, H-32, H-42, H-42M, H-43, H-43M, H-100, H-210, H-310, H-320, H-32ST, H-320ST, H-42STE, H-42STV, H-32T, H-34, H-34HL, H-10CX, H-31I, H-32I, H-32S, and H-42S, which are products of Showa Denko Co.

In the hydrated alumina, water of crystallization undergoes a dehydro-endothermic reaction at a temperature of around 300° C., whereby flame-retardancy is exhibited.

As examples of the ammonium polyphosphate used in combination with the above components there are mentioned trade names Sumi Safe P (a product of Sumitomo Chemical Co.), Exolit 422, Exolit 462, Hostflam TPAP745 (products of Hoechst Co.), and Tellerjue C60, C70, C80 (products of Chisso Co.).

The ammonium polyphosphate acts as a foaming agent during combustion. More particularly, during combustion, the ammonium polyphosphate forms an adiabatic foam layer, causing the internal temperature of a surface layer of material to drop, whereby flame-retardancy is exhibited.

Generally, if the proportion of the flame retardant is too large, a lowering of adhesive strength results, while if it is too small, the tape will become less flame-retardant, and there is a fear that the flame-retardant characteristics defined in the standard concerned may not be satisfied.

More specifically, in the flame retardant containing phosphazene, if the flame retardant proportion exceeds 100 parts by weight in the case of phosphazene, exceeds 200 parts by weight in the case of hydrated alumina, or exceeds 100 parts by weight in the case of ammonium polyphosphate, based on 100 parts by weight of the photo-curing pressure-sensitive adhesive, a lowering of adhesive strength may result. As a matter of course, if plural flame retardants are used in large amounts, the adhesive strength will be further deteriorated. In such a case it is inevitably required to increase the thickness of the adhesive tape.

Further, if the flame retardant proportion is less than 5 parts by weight in the case of phosphazene, less than 10 parts by weight in the case of hydrated alumina, or less than 5 parts by weight in the case of ammonium polyphosphate, based on 100 parts by weight of the photo-curing pressure-sensitive adhesive, the effect of flame-retardancy will be deteriorated and there is a fear that the flame-retardant characteristics defined in the standard concerned may not be satisfied.

In the flame retardant containing inorganic coated red phosphorus, if the flame retardant proportion exceeds 50 parts by weight in the case of inorganic red phosphorus, exceeds 200 parts by weight in the case of hydrated alumina, or exceeds 200 parts by weight in the case of ammonium polyphosphate, based on 100 parts by weight of the photo-curing pressure-sensitive adhesive, a lowering of adhesive strength may result.

If the flame retardant proportion is less than 5 parts by weight in the case of inorganic coated red phosphorus, less than 10 parts by weight in the case of hydrated alumina, or less than 10 parts by weight in the case of ammonium polyphosphate, based on 100 parts by weight of the photo-curing pressure-sensitive adhesive, the effect of flame-retardancy will be deteriorated and there is a fear that the flame-retardant characteristics defined in the standard concerned may not be satisfied.

To improve such workability as applicability of the photo-curing pressure-sensitive adhesive used in the present invention, a (metha)acrylic alkyl ester monomer and a polar group-containing monomer are subjected to bulk polymerization for thickening and the adhesive is used in this thickened state. As the said acrylic high molecular weight polymer, one having a weight average molecular weight of 200,000 to 3,000,000 is preferred.

If the weight average molecular weight of the acrylic high molecular weight polymer is less than 200,000, it is difficult to obtain a pressure-sensitive adhesive composition with a viscosity as high as several thousand to several ten thousand cP, taking applicability into account.

Thus, such a small value is not desirable. If the weight average molecular weight is larger than 3,000,000, there will arise no special problem in connection with characteristics of the adhesive tape, but it is difficult to mass-produce the acrylic high molecular weight polymer. Thus, such a large value is not desirable, either.

The proportion of the acrylic high molecular weight polymer in the pressure-sensitive adhesive composition is adjusted in accordance with desired tackiness and viscosity in application, but is usually in the range of 5 to 50 wt % in the adhesive composition. As a main component of the acrylic high molecular weight polymer having a photo-curing functional group there usually is employed a copolymer of a (metha)acrylic acid alkyl ester monomer and a polar group-containing monomer, e.g., a copolymer of 2-ethylhexyl acrylate and acrylic acid, a copolymer of isooctyl acrylate and 2-hydroxyethyl methacrylate, and a terpolymer of 2-ethylhexyl acrylate, acrylic acid, and 2-hydroxyethyl methacrylate, provided there is made no special limitation thereto.

As examples of the above (metha)acrylic acid alkyl ester monomer there are mentioned (metha)acrylic acid esters containing alkyl groups of not more than 20 carbon atoms, typical of which are ethyl, propyl, butyl, pentyl, hexyl, 2-ethylhexyl, octyl, isooctyl, nonyl, isononyl, and decyl.

These (metha)acrylic alkyl esters may be used each alone or in combinations of two or more.

As examples of the above polar group-containing monomer there are mentioned polymerizable unsaturated monomers containing a polar group such as carboxyl, hydroxyl, or amino group, typical of which are acrylic acid, methacrylic acid, itaconic acid, 2-hydroxyethyl methacrylate, 2-hydroxypropyl methacrylate, dimethylaminoethyl acrylate, acrylonitrile, methacrylonitrile, and N-vinyl-2-pyrrolidone.

It is preferable that the proportion of the polar group-containing monomer be in the range of 1 to 30 wt % relative to 99-70 wt % of the (metha)acrylic acid alkyl ester. If the proportion of the polar group-containing monomer is less than 1 wt %, the adhesive strength of the adhesive tape will be deteriorated, and also where it is more than 30 wt %, a lowering of adhesive strength of the adhesive tape will result. Thus, both such cases are undesirable. The polar group-containing monomers exemplified above may be used each alone or in combinations of two or more.

As the photo-polymerization initiator used in the present invention there may be employed any of conventional photo-polymerization initiators used in radical photo-polymerization of for example vinyl and (metha)acryloyloxy groups or radical photo-polymerization initiators used for UV-curing type resins. Examples are such compounds as benzoin, benzoin methyl ether, benzoin ethyl ether, trichloroacetophenone, benzophenone, and benzyl.

The following photo-polymerization initiators available from Ciba Specialty Chemicals Co. are also employable: benzyl dimethyl ketal compounds such as 2,2-dimethoxy-1,2-diphenylethane-1-one (Irgacure 651, a product of Ciba Specialty Chemicals Co.), α-hydroxyketone compounds such as 1-hydroxycyclohexyl phenyl ketone (Irgacure 184, a product of Ciba Specialty Chemicals Co.), and 2-hydroxy-2-methyl-1-phenylpropane-1-one (DAROCUR 1173, a product of Ciba Specialty Chemicals Co.), α-aminoketone compounds such as 2-benzyl-2-dimethylamino-1-(4-morpholinophenyl)butanone-1 (Irgacure 369, a product of Ciba Specialty Chemicals Co.), bisacylphosphine oxide compounds such as bis(2,4,6-trimethylbenzoyl)phenylphosphine oxide (Irgacure 819, a product of Ciba Specialty Chemicals Co.), 1:3 mixtures (Irgacure 1700, a product of Ciba Specialty Chemicals Co.) of bisacylphosphine oxides such as bis(2,6-dimethoxybenzoyl)-2,4,4-trimethylpentyl phosphine oxide and DAROCUR 1173, 1:1 mixtures (Irgacure 1850, a product of Ciba Specialty Chemicals Co.) of bisacylphosphine oxides such as bis(2,6-dimethoxybenzoyl)-2,4,4-trimethylpentyl phosphine oxide and Irgacure 184, and benzoin ether compounds such as benzoin ethyl ether and benzoin propyl ether. Particularly preferred are such photo-polymerization initiators as bisacylphosphine oxide compounds which upon radiation of light produce two or more active species (radicals) from one molecule of each photo-polymerization initiator.

It is preferable that these photo-polymerization initiators be each used at a proportion of 0.01 to 5 parts by weight relative to 100 parts by weight of the foregoing high molecular weight polymer. If the proportion of the photo-polymerization initiator used is smaller than 0.01 part by weight, it will be difficult to let the photo-curing reaction be completed to a satisfactory extent. If it is larger than 5 part by weight, the molecular weight of the resulting adhesive polymer will become smaller. Thus, both cases are undesirable in view of adhesive tape characteristics.

As a poly-functional polymerizable compound incorporated as a cross-inking agent in the pressure-sensitive adhesive which comprises the above acrylic adhesive high molecular weight polymer, it is preferable to use about 0.01 to 5 parts by weight of a photo-polymerizable compound such as a poly-functional (metha) acrylic monomer relative to 100 parts by weight of the acrylic adhesive high molecular weight polymer. As examples of such a poly-functional photo-polymerizable compound are mentioned hexanediol(metha)acrylate, neopentyl di(metha)acrylate, penta-erythritol di(metha)acrylate, trimethylolpropane tri(metha)acrylate, dipentaerythritol hexa(metha)acrylate, polyethylene glycol di(metha)acrylate, polypropylene glycol di(metha)acrylate, epoxy acrylate oligomers, polyester acrylate oligomers, and urethane acrylate oligomers.

Poly-functional epoxy resins are also employable as cross-linking agents, examples of which include N,N,N,N-tetraglycidyl m-xylenediamine and 1,3-bis(N,N-diglycidylaminomethyl)cyclohexane.

It is preferable that about 0.3 to 3 parts by weight of a thixotropic agent, based on 100 parts of the acrylic high molecular weight polymer, be incorporated in the pressure-sensitive adhesive which comprises the acrylic high molecular weight polymer. As examples of the thixotropic agent are mentioned trade names #6900-20×, #6650, #305, and #3800, which are products of Kusumoto Kasei Co., Aerosile 300 which is a product of Nippon Aerosile Co., and SAN, STN, SEN, and SPN, which are products of CO.OP Chemical Co.

It is preferable for the flame-retardant adhesive tape of the present invention to have an oxygen index of not smaller than 23, more preferably not smaller than 25, as an index of its flame retardancy. If the oxygen index is smaller than 23, the adhesive tape may become flammable and the self-extinguishing property thereof may be lost. Therefore, such a small value is not preferable.

In the method for producing the thermo-reactive flame-retardant adhesive tape according to the present invention, a solvent-less type photo-curing pressure-sensitive adhesive containing a flame-retardant is applied onto a substrate to a thickness of 5-500 μm and the resulting photo-curing pressure-sensitive adhesive layer is cured by light irradiation in an inert gas atmosphere or while applying a transparent protective film from above. Therefore, the pressure-sensitive adhesive layer can be prevented from being impaired its surface effect by the oxygen contained in air. Particularly, in case of using a transparent protective film, not only the volatilization of monomer caused by the generation of heat on curing is prevented, but also the thickness of the thermo-reactive flame-retardant adhesive tape is made uniform.

In this case, it is preferable that the coating thickness of the pressure-sensitive adhesive be not smaller than 5 μm, more preferably not smaller than 50 μm. If the coating thickness of the pressure-sensitive adhesive is smaller than 5 μm, there will not be obtained a thermo-reactive flame-retardant adhesive tape because the coating thickness is smaller than the particle diameter of the flame retardant, and thus such a small thickness is not preferable. An adhesive coating thickness exceeding 500 μm is not preferable, either, because bubbles would be mixed into the tape.

To what use the thermo-reactive flame-retardant adhesive tape of the present invention is to be applied is not specially limited insofar as flame-retardancy is required of that use. But the adhesive tape of the invention is particularly suitable for various electronic parts which are apt to be harmful by halogen gas. It constitutes electronic parts in a bonded state thereto. Such electronic parts are not specially limited. For example, in a transformer, the tape is used for interlayer isolation or for the lamination of electromagnetic shielding films.

### EXAMPLES

The thermo-reactive flame-retardant adhesive tape and the method for producing the same according to the present invention will be described below by way of concrete examples thereof. However, it is to be understood that the invention is not limited to those examples. In the following Examples and Comparative Examples, part and parts represent part by weight and parts by weight, respectively.

### Example 1

5 parts of 2-hydroxyethyl acrylate, 5 parts of propoxyphosphazene (trade name: SPR-100, a product of Otsuka Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive compoisition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm and the thus-coated film was irradiated with light through a transparent protective film superimposed thereon to give a thermo-reactive flame-retardant adhesive tape. As shown in Table 1, this adhesive tape was superior in drip suppressing effect and had an oxygen index of 23, proving to possess self-extinguishing property.

### Example 2

50 parts of 2-hydroxyethyl acrylate, 100 parts of propoxyphosphazene (trade name: SPR-100, a product of Otsuka Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. The pressure-sensitive adhesive was then applied onto a polyester film (50 μm thick) to a thickness of 500 μm. Then, the thus-coated film was irradiated with light through a transparent protective film superimposed thereon to give a thermo-reactive flame-retardant adhesive tape. As shown in Table 1, this adhesive tape was superior in drip suppressing effect and had an oxygen index of 25, proving to possess self-extinguishing property.

### Example 3

5 parts of 2-hydroxyethyl acrylate, 20 parts of propoxyphosphazene (trade name: SPR-100, a product of Otsuka Chemical Co.), 50 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm and the thus-coated film was irradiated with light through a transparent protective film superimposed thereon to give a thermo-reactive flame-retardant adhesive tape. As shown in Table 1, this adhesive tape was superior in drip suppressing effect and had an oxygen index of 28, proving to possess flame-retardancy.

### Example 4

5 parts of 2-hydroxyethyl acrylate, 20 parts of propoxyphosphazene (trade name: SPR-100, a product of Otsuka Chemical Co.), 100 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 27, proving to possess self-extinguishing property.

### Example 5

10 parts of 2-hydroxyethyl acrylate, 20 parts of propoxyphosphazene (trade name: SPR-100, a product of Otsuka Chemical Co.), 200 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive film. As shown in Table 1, this adhesive tape was superior in drip suppressing effect and had an oxygen index of 33, proving to possess flame-retardancy.

### Example 6

10 parts of 2-hydroxyethyl acrylate, 100 parts of propoxyphosphazene (trade name: SPR-100, a product of Otsuka Chemical Co.), 200 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 37, proving to possess flame-retardancy.

### Example 7

50 parts of 2-hydroxyethyl acrylate, 20 parts of propoxyphosphazene (trade name: SPR-100, a product of Otsuka Chemical Co.), 10 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 25, proving to possess self-extinguishing property.

### Example 8

50 parts of 2-hydroxyethyl acrylate, 20 parts of propoxyphosphazene (trade name: SPR-100, a product of Otsuka Chemical Co.), 50 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a phot-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 5 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 24, proving to possess self-extinguishing property.

### Example 9

5 parts of 2-hydroxyethyl acrylate, 20 parts of propoxyphosphazene (trade name: SPR-100, a product of Otsuka Chemical Co.), 5 parts of ammonium polyphosphate (trade name: Sumi Safe P, a product of Sumitomo Chemical Co), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 25, proving to possess self-extinguishing effect.

### Example 10

5 parts of 2-hydroxyethyl acrylate, 20 parts of propoxyphosphazene (trade name: SPR-100, a product of Otsuka Chemical Co.), 100 parts of ammonium polyphosphate (trade name:Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 27, proving to possess self-extinguishing property.

### Example 11

50 parts of 2-hydroxyethyl acrylate, 100 parts of propoxyphosphazene (trade name: SPR-100, a product of Otsuka Chemical Co.), 100 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-poymerization intiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 32, proving to possess flame-retardancy.

### Example 12

5 part of 2-hydroxyethyl acrylate, 20 parts of propoxyphosphazene (trade name: SPR-100, a product of Otsuka Chemical Co.), 50 parts of hydrated alumina (trade name: H-21, a product of Showa Denko Co.), 10 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressuer-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 29, proving to possess flame-retardancy.

### Example 13

50 parts of 2-hydroxyethyl acrylate, 20 parts of propoxyphosphazene (trade name: SPR-100, a product of Otsuka Chemical Co.), 100 part of hydrated alumina (trade name: H-21, a product of Showa Denko Co.), 10 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 33, proving to possess flame-retardancy.

### Example 14

50 parts of 2-hydroxyethyl acrylate, 20 parts of propoxyphosphazene (trade name: SPR-100, a product of Otsuka Chemical Co.), 10 parts of hydrated alumina (trade name: H-21, a product of Showa Denko Co.), 100 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 32, proving to possess flame-retardancy.

### Example 15

50 parts of 2-hydroxyethyl acrylate, 100 parts of propoxyphosphazene (trade name: SPR-100, a product of Otsuka Chemical Co.), 200 parts of hydrated alumina (trade name: H-21, a product of Showa Denko Co.), 100 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 39, proving to possess flame-retardancy.

### Example 16

50 parts of 2-hydroxyethyl acrylate, 20 parts of propoxyphosphazene (trade name: SPR-100, a product of Otsuka Chemical Co.), 200 parts of hydrated alumina (trade name: H-21, a product of Showa Denko Co.), 5 parts of ammonium polyphosphate (trade name:Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film, (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 33, proving to possess flame-retardancy.

### Example 17

50 parts of 2-hydroxyethyl acrylate, 20 parts of propoxyphosphazene (trade name: SPR-100, a product of Otsuka Chemical Co.), 200 parts of hydrated alumina (trade name: H-21, a product of Showa Denko Co.), 10 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 35, proving to possess flame-retardancy.

### Example 18

5 parts of 2-hydroxyethyl acrylate, 20 parts of propoxyphosphazene (trade name: SPR-100, a product of Otsuka Chemical Co.), 50 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 1, this adhesive tape was superior in drip suppressing effect and had an oxygen index of 27, proving to possess self-extinguishing property.

### Comparative Example 1

0.02 part of 1,3-bis(N,N-diglycidylaminomethyl)cyclohexane and 0.3 part of Irgacure 819 (a product of Ciba Specialty Chemicals Co.) as a photo-polymerization initiator were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give an adhesive tape. As shown in Table 2, this adhesive tape was devoid of self-extinguishing property and was inferior in drip suppressing effect.

### Comparative Example 2

100 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. The pressure-sensitive adhesive was applied onto a polyester film (50 μm thick) to a thickness of 70 μm. The thus-coated film was irradiated with light through a transparent protective film superimposed thereon to give a flame retardant adhesive tape. As shown in Table 2, this adhesive tape was devoid of self-extinguishing property and was inferior in drip suppressing effect.

### Comparative Example 3

20 parts of propoxyphosphazene (trade name: SPR-100, a product of Otsuka Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film to give a flame retardant adhesive tape. As shown in Table 2, this adhesive tape was devoid of self-extinguishing property and was inferior in drip suppressing effect.

### Comparative Example 4

20 parts of propoxyphosphazene (trade name: SPR-100, a product of Otsuka Chemical Co.), 50 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a flame retardant adhesive tape. As shown in Table 2, this adhesive tape was devoid of self-extinguishing property and was inferior in drip suppressing effect.

### Comparative Example 5

20 parts of propoxyphosphazene (trade name: SPR-100, a product of Otsuka Chemical Co.), 50 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals) as a photo-polymerization initiator, were added to a pressure-sensitive adhesive composition consisting of 22.8 parts of an acrylic acid copolymer and 77.2 parts of 2-ethylheyxl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a flame retardant adhesive tape. As shown in Table 2, this adhesive tape was devoid of self-extinguishing property and was inferior in drip suppressing effect.

### Comparative Example 6

20 parts of propoxyphosphazene (trade name: SPR-100, a product of Otsuka Chemical Co.), 50 parts of hydrated alumina (trade name: H-21, a product of Showa Denko Co.), 10 parts of ammonium polyphosphate (trade name:Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a flame-retardant adhesive tape. As shown in Table 2, this adhesive tape was inferior in drip suppressing effect.

### Comparative Example 7

100 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a flame retardant adhesive tape. As shown in Table 2, this adhesive tape was devoid of self-extinguishing property and was inferior in drip-suppressing effect.

The flame-retardant adhesive tapes obtained in the above Examples and Comparative Examples were measured for various characteristics by the following methods. Results of the measurements are as set out in Tables 1 and 2.

[Adhesive Strength]

An adhesive surface of a test piece of each of the above flame-retardant adhesive tapes was affixed lightly to a stainless steel plate as an adherend in accordance with a method defined by JIS Z 0237-1991, then a 2 kg roller was brought into pressure contact with the test piece from above through a polyester film to afford a laminate, which after 20 minutes was subjected to a peeling test at a peel rate of 300 mm/min by means of an Aikoh tensile machine to determine an adhesive strength of the test piece.

[Oxygen Index]

In a condition in which a material continues to burn like a candle flame within a slowly rising gaseous mixture of oxygen and nitrogen, the concentration of oxygen is decreased gradually. An oxygen concentration at which the material can barely continue to burn is designated a limit oxygen index. By determining this oxygen index it is possible to determine the combustibility of a high molecular material. As the barometer of combustibility, a test piece having an oxygen index of not larger than 22 is regarded as being flammable, one having an oxygen index of 23 to 27 is regarded as being self-extinguishing, and one having an oxygen index of not smaller than 28 is regarded as being flame-retardant. Generally, one possessing self-extinguishing property or a higher oxygen index is regarded as being flame-retardant. The measurement of oxygen index was made in accordance with a method defined by JIS K 7201. More specifically, a test piece 150 mm long by 60 mm wide was attached to a U-shaped holder and a minimum oxygen concentration necessary for the test piece to continue burning at a burning length of 50 mm after the start of flaming was measured.

TABLE 1

| | | Flame | Dripping | | | | |
|---|---|---|---|---|---|---|---|
| | | Retardant | Inhibitor | Film | Adhesive | | |
| | | (part by | (part by | Thickness | Strength | Occurrence | Oxygen |
| | Flame Retardant | weight) | weight) | (μm) | (N/10 mm) | of Dripping | Index |
| Example 1 | phosphazene | 5 | 5 | 500 | 9.0 | No | 23 |
| Example 2 | phosphazene | 100 | 50 | 500 | 8.5 | No | 25 |
| Example 3 | phosphazene/hydrated alumina | 20/50 | 5 | 70 | 4.0 | No | 28 |
| Example 4 | phosphazene/hydrated alumina | 5/100 | 10 | 70 | 3.5 | No | 27 |
| Example 5 | phosphazene/hydrated alumina | 20/200 | 10 | 70 | 2.5 | No | 33 |
| Example 6 | phosphazene/hydrated alumina | 100/200 | 10 | 500 | 3.0 | No | 37 |
| Example 7 | phosphazene/hydrated alumina | 20/10 | 50 | 500 | 8.9 | No | 25 |
| Example 8 | phosphazene/hydrated alumina | 20/50 | 50 | 5 | 3.5 | No | 24 |
| Example 9 | phosphazene/ammonium polyphosphate | 20/5 | 5 | 500 | 9.2 | No | 25 |
| Example 10 | phosphazene/ammonium polyphosphate | 5/100 | 10 | 70 | 3.2 | No | 27 |
| Example 11 | phosphazene/ammonium polyphosphate | 100/100 | 50 | 70 | 3.0 | No | 32 |
| Example 12 | phosphazene/hydrated | 20/50/10 | 5 | 70 | 4.1 | No | 29 |
| | alumina/ammonium polyphosphate | | | | | | |
| Example 13 | phosphazene/hydrated | 20/100/10 | 50 | 70 | 3.2 | No | 33 |
| | alumina/ammonium polyphosphate | | | | | | |
| Example 14 | phosphazene/hydrated | 20/10/100 | 50 | 70 | 3.0 | No | 32 |
| | alumina/ammonium polyphosphate | | | | | | |
| Example 15 | phosphazene/hydrated | 100/200/100 | 50 | 500 | 2.5 | No | 39 |
| | alumina/ammonium polyphosphate | | | | | | |
| Example 16 | phosphazene/hydrated | 20/200/5 | 50 | 70 | 2.9 | No | 33 |
| | alumina/ammonium polyphosphate | | | | | | |
| Example 17 | phosphazene/hydrated | 20/200/10 | 50 | 70 | 2.6 | No | 35 |
| | alumina/ammonium polyphosphate | | | | | | |
| Example 18 | Phosphazene/ammonium polyphosphate | 20/50 | 10 | 70 | 5.4 | No | 27 |

TABLE 2

| | | Flame | Dripping | | | | |
|---|---|---|---|---|---|---|---|
| | | Retardant | Inhibitor | Film | Adhesive | Occurrence | |
| | | (part by | (part by | Thickness | Strength | of | Oxygen |
| | Flame Retardant | weight) | weight) | (μm) | (N/10 mm) | Dripping | Index |
| Comparative | not added | 0 | 0 | 70 | 9.0 | Yes | 16 |
| Example 1 | | | | | | | |
| Comparative | hydrated alumina | 100 | 0 | 70 | 3.8 | Yes | 21 |
| Example 2 | | | | | | | |
| Comparative | phosphazene | 20 | 0 | 70 | 3.5 | Yes | 21 |
| Example 3 | | | | | | | |
| Comparative | Phosphazene/hydrated | 20/50 | 0 | 70 | 2.9 | Yes | 22 |
| Example 4 | alumina | | | | | | |
| Comparative | Phosphazene/ | 20/50 | 0 | 70 | 3.0 | Yes | 22 |
| Example 5 | ammonium | | | | | | |
| | polyphosphate | | | | | | |
| Comparative | Phosphazene/hydrated | 20/50/10 | 0 | 70 | 4.0 | Yes | 23 |
| Example 6 | alumina/ammonium | | | | | | |
| | polyphosphate | | | | | | |
| Comparative | ammonium | 100 | 0 | 70 | 4.0 | Yes | 21 |
| Example 7 | polyphosphate | | | | | | |
| Comparative | red phosphorus | 50 | 0 | 70 | 4.0 | Yes | 23 |
| Example 8 | | | | | | | |
| Comparative | red phosphorus/ | 20/50 | 0 | 70 | 4.0 | Yes | 25 |
| Example 9 | hydrated alumina | | | | | | |
| Comparative | red phosphorus/ | 20/50 | 0 | 70 | 3.9 | Yes | 25 |
| Example 10 | ammonium | | | | | | |
| | polyphosphate | | | | | | |

### Example 19

5 parts of 2-hydroxyethyl acrylate, 5 parts of an inorganic coated red phosphorus flame retardant (trade name: CP-A15F, a product of Nippon Chemical Industrial Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 23, proving to possess self-extinguishing property.

### Example 20

50 parts of 2-hydroxyethyl acrylate, 50 parts of an inorganic coated red phosphorus flame retardant (trade name: CP-A15F, a product of Nippon Chemical Industrial Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 25, proving to possess self-extinguishing property.

### Example 21

50 parts of 2-hydroxyethyl acrylate, 10 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 Sn. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 23, proving to possess self-extinguishing property.

### Example 22

5 parts of 2-hydroxyethyl acrylate, 200 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 30, proving to possess flame-retardancy.

### Example 23

10 parts of 2-hydroxyethyl acrylate, 5 parts of an inorganic coated red phosphorus flame retardant (trade name: CP-A15F, a product of Nippon Chemical Industrial Co.), 200 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 33, proving to possess flame-retardancy.

### Example 24

5 parts of 2-hydroxyethyl acrylate, 20 parts of an inorganic coated red phosphorus flame retardant (trade name: CP-A15F, a product of Nippon Chemical Industrial Co.), 50 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 28, proving to possess flame-retardancy.

### Example 25

50 parts of 2-hydroxyethyl acrylate, 50 parts of an inorganic coated red phosphorus flame retardant (trade name: CP-A15F, a product of Nippon Chemical Industrial Co.), 10 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 5 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 26, proving to possess self-extinguishing property.

### Example 26

50 parts of 2-hydroxyethyl acrylate, 50 parts of an inorganic coated red phosphorus flame retardant (trade name: CP-A15F, a product of Nippon Chemical Industrial Co.), 200 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 pars of 2-ethylhexyl acrylate, followed by intimate mixing, to afford a pressure-sensitive adhesive. Then, the pressure-sensitive adhesive was applied onto a polyester film (50 μm thick) to a thickness of 500 μm.

The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 38, proving to possess flame-retardancy.

### Example 27

50 parts of 2-hydroxyethyl acrylate, 10 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 part of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 24, proving to possess self-extinguishing property.

### Example 28

5 parts of 2-hydroxyethyl acrylate, 200 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressuer-sensitive adhesive composition consisting of 22.8 parts of an acrylic acid copolymer and 77.2 parts of 2-ethylhenxyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 30, proving to possess flame-retardancy.

### Example 29

10 parts of 2-hydroxyethyl acrylate, 5 parts of an inorganic coated red phosphorus flame retardant (trade name: CP-A15F, a product of Nippon Chemical Industrial Co.), 200 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 34, proving to possess flame retardancy.

### Example 30

10 parts of 2-hydroxyethyl acrylate, 20 parts of an inorganic coated red phosphorus flame retardant (trade name: CP-A15F, a product of Nippon Chemical Industrial Co.), 50 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 28, proving to possess flame-retardancy.

### Example 31

50 parts of 2-hydroxyethyl acrylate, 50 parts of an inorganic coated red phosphorus flame retardant (trade name: CP-A15F, a product of Nippon Chemical Industrial Co.), 10 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 26, proving to possess self-extinguishing property.

### Example 32

50 parts of 2-hydroxyethyl acrylate, 50 parts of an inorganic coated red phosphorus flame retardant (trade name: CP-A15F, a product of Nippon Chemical Industrial Co.), 200 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylheyxl acrylate, followed by intimate mixing, to afford a pressure-sensitive adhesive. Then, the pressure-sensitive adhesive was applied onto a polyester film (50 μm thick) to a thickness of 500 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 35, proving to possess flame-retardancy.

### Example 33

50 parts of 2-hydroxyethyl acrylate, 100 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals) as a photo-polymerization initiator, were added to a pressure-sensitive adhesion composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a thermo-reactive flame-retardant adhesive tape. As shown in Table 3, this adhesive tape was superior in drip suppressing effect and had an oxygen index of 28, proving to possess self-extinguishing property.

### Example 34

50 parts of 2-hydroxyethyl acrylate, 100 parts of ammonium polyphosphate (trade name: Sumi Safe P, a product of Sumitomo Chemical Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irraddiated with light through a transparent protective film superimposed thereon to give a thermo-reactive flame-retardant adhesive tape. As shown in Table 3, this adhesive tape was superior in drip suppressing effect and had an oxygen index of 28, proving to possess self-extinguishing property.

### Comparative Example 8

50 parts of an inorganic coated red phoshporus flame retardant (trade name: CP-A15F, a product of Nippon Chemical Industrial Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a flame-retardant adhesive tape. As shown in Table 2, this adhesive tape was inferior in drip suppressing effect although it proved to possess self-extinguishing property.

### Comparative Example 9

20 parts of an inorganic coated red phosphorus flame retardant (trade name: CP-A15F, a product of Nippon Chemical Industrial Co.), 50 parts of hydrated alumina (trade name: H-21, a product of Showa Denko Co.), 0.02 part of 1,3-bis(N,N-diglycidylaminomethyl)cyclohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a flame-retardant adhesive tape. As shown in Table 2, this adhesive tape was inferior in drip suppressing effect although it proved to possess self-extinguishing property.

### Comparative Example 10

20 parts of an inorganic coated red phosphorus flame retardant (trade name: CP-A15F, a product of Nippon Chemical Industrial Co.), 50 parts of ammonium polyphosphate (trade name: Sumi Safe P, a product of Sumitomo Chemical Co.), 0.02 part of 1,3-bis(N,N-diglycidylaminomethyl)cylohexane, and 0.3 part of Irgacure 819 (a product of Ciba Specialty Chemicals Co.) as a photo-polymerization initiator, were added to a pressure-sensitive adhesive composition consisting of 22.8 parts of an acrylic acid copolymer and 77.2 parts of 2-ethylhexyl acrylate, followed by intimate mixing, to afford a pressure-sensitive adhesive. Then, the pressure-sensitive adhesive was applied onto a polyester film (50 μm thick) to a thickness of 70 μm. The thus-coated film was irradiated with light through a transparent protective film superimposed thereon to give a flame-retardant adhesive tape. As shown in Table 2, this adhesive tape was inferior in drip suppressing effect although it proved to possess self-extinguishing property.

Characteristics of the flame-retardant adhesive tapes obtained above are set out in Tables 3 and 2.

TABLE 3

| | | Flame | Dripping | | | | |
|---|---|---|---|---|---|---|---|
| | | Retardant | Inhibitor | Film | Adhesive | Occurrence | |
| | | (part by | (part by | Thickness | Strength | of | Oxygen |
| | Flame Retardant | weight) | weight) | (μm) | (N/10 mm) | Dripping | Index |
| Example 19 | red phosphorus | 5 | 5 | 500 | 9.0 | No | 23 |
| Example 20 | red phosphorus | 50 | 50 | 500 | 8.5 | No | 25 |
| Example 21 | hydrated alumina | 10 | 50 | 500 | 9.0 | No | 23 |
| Example 22 | hydrated alumina | 200 | 5 | 70 | 3.0 | No | 30 |
| Example 23 | red phosphorus/ | 5/200 | 10 | 70 | 2.5 | No | 33 |
| | hydrated alumina | | | | | | |
| Example 24 | red phosphorus/ | 20/50 | 5 | 70 | 6.0 | No | 28 |
| | hydrated alumina | | | | | | |
| Example 25 | red phosphorus/ | 50/10 | 50 | 5 | 2.4 | No | 26 |
| | hydrated alumina | | | | | | |
| Example 26 | red phosphorus/ | 50/200 | 50 | 500 | 7.3 | No | 38 |
| | hydrated alumina | | | | | | |
| Example 27 | ammonium | 10 | 50 | 500 | 9.0 | No | 24 |
| | polyphosphate | | | | | | |
| Example 28 | ammonium | 200 | 5 | 70 | 3.5 | No | 30 |
| | polyphosphate | | | | | | |
| Example 29 | red phosphorus/ | 5/200 | 10 | 70 | 3.0 | No | 34 |
| | ammonium | | | | | | |
| | polyphosphate | | | | | | |
| Example 30 | red phosphorus/ | 20/50 | 5 | 70 | 4.0 | No | 28 |
| | ammonium | | | | | | |
| | polyphosphate | | | | | | |
| Example 31 | red phosphorus/ | 50/10 | 50 | 70 | 3.5 | No | 26 |
| | ammonium | | | | | | |
| | polyphosphate | | | | | | |
| Example 32 | red phosphorus/ | 50/200 | 50 | 500 | 5.7 | No | 35 |
| | ammonium | | | | | | |
| | polyphosphate | | | | | | |
| Example 33 | hydrated alumina | 100 | 50 | 70 | 4.0 | No | 28 |
| Example 34 | ammonium | 100 | 50 | 70 | 4.2 | No | 28 |
| | polyphosphate | | | | | | |

### INDUSTRIAL APPLICABILITY

As set forth above, the present invention resides in a thermo-reactive flame-retardant adhesive tape comprising a substrate and a solvent-less type photo-curing pressure-sensitive adhesive applied onto the substrate, the solvent-less type photo-curing pressure-sensitive adhesive comprising a photo-curing pressure-sensitive adhesive, as well as a dripping inhibitor and a flame retardant both added into the photo-curing pressure-sensitive adhesive, the photo-curing pressure-sensitive-adhesive containing as main components at least a (metha)acrylic acid alkyl ester monomer, a polar group-containing monomer, and a photo-polymerization initiator. Thus, by carrying out the present invention it is possible to provide a thermo-reactive flame-retardant adhesive tape superior in both flame-retardancy and drip suppressing effect.

1. A thermo-reactive flame-retardant adhesive tape comprising a substrate and a solvent-less type photo-curing pressure-sensitive adhesive applied onto the substrate, the solvent-less type photo-curing pressure-sensitive adhesive comprising a photo-curing pressure-sensitive adhesive, as well as a dripping inhibitor and a flame retardant both added into the photo-curing pressure-sensitive adhesive, the photo-curing pressure-sensitive adhesive containing as main components at least a (metha)acrylic acid alkyl ester monomer, a polar group-containing monomer, and a photo-polymerization initiator.

2. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group and 5-100 parts by weight of phosphazene are added as the dripping inhibitor and the flame retardant, respectively, to the photo-curing pressure-sensitive adhesive.

3. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group, as well as 5-100 parts by weight of phosphazene and 10-200 parts by weight of hydrated alumina, are added as the dripping inhibitor and the flame retardant, respectively, to the photo-curing pressure-sensitive adhesive.

4. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group, as well as 5-100 parts by weight of phosphazene and 5-100 parts by weight of ammonium polyphosphate, are added as the dripping inhibitor and the flame retardant, respectively, to the photo-curing pressure-sensitive adhesive.

5. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group, as well as 5-100 parts by weight of phosphazene and 10-200 parts by weight of hydrated alumina and 5-100 parts by weight of ammonium polyphosphate, are added as the dripping inhibitor and the flame retardant, respectively, to the photo-curing pressure-sensitive adhesive.

6. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group and 5-50 parts by weight of inorganic coated red phosphorus are added as the dripping inhibitor and the flame retardant, respectively, to the photo-curing pressure-sensitive adhesive.

7. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group and 10-200 parts by weight of hydrated alumina are added as the dripping inhibitor and the flame retardant, respectively, to the photo-curing pressure-sensitive adhesive.

8. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group, as well as 5-50 parts by weight of inorganic coated red phosphorus and 10-200 parts by weight of hydrated alumina, are added as the dripping inhibitor and the flame retardant, respectively, to the photo-curing pressure-sensitive adhesive.

9. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group and 10-200 parts by weight of ammonium polyphosphate are added as the dripping inhibitor and the flame retardant, respectively, to the photo-curing pressure-sensitive adhesive.

10. A thermo-reactive flame-retardant adhesive tape according to claim 1 wherein, based on 100 parts by weight of the photo-curing pressure-sensitive adhesive, 5-50 parts by weight of a hydroxyl-containing monomer having a photo-active functional group, as well as 5-50 parts by weight of inorganic coated red phosphorus and 10-200 parts by weight of ammonium polyphosphate, are added as the dripping inhibitor and the flame retardant, respectively.

11. A thermo-reactive flame-retardant adhesive tape according to any of claims 1 to 10, having an oxygen index of not smaller than 23.

12. A method for producing the thermo-reactive flame-retardant adhesive tape according to any of claims 1 to 10, characterized in that a layer of the photo-curing pressure-sensitive adhesive formed by applying the solvent-less type photo-curing photo-sensitive adhesive containing the flame retardant onto the substrate to a thickness of 5-500 μm is cured by light irradiation in an inert gas atmosphere or while covering the layer with a transparent protective film from above.
